(19) United States
(12) Patent Application Publication
(10) Pub. No.: US 2012/0265614 A1
(43) Pub. Date: Oct. 18, 2012

(54) User-Based Segmentation and Selection of Offers

(76) Inventors: Mark Douglas, Marina Del Ray, CA (US); Kevaughn Bullock, South Pasadena, CA (US)

(21) Appl. No.: 13/087,157

(22) Filed: Apr. 14, 2011

(51) Int. Cl. G06Q 30/00

(52) U.S. Cl. 705/14.54; 705/14.53

(57) ABSTRACT

There is disclosed a method for user-based segmentation and selection of offers. The method includes aggregating user activity data based upon online activity of a user and generating user segment data in response to a web page request by the user and a segmentation request incorporating a plurality of user queries based upon the user activity data. The method then includes providing the user segment data to an offer server in response to a segment request from the offer server.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to user-based segmentation and selection of offers.

2. Description of the Related Art

Online advertisement continues to grow as Internet users spend increasing time consuming web-based content. In efforts to present relevant advertisements to users, advertisers have sought increasing amounts of data about users. This information has typically been limited to information internal to a particular website or group of websites. As a result, large advertising companies, providing advertising across many related and unrelated sites have formed in order to gather data pertaining to particular users.

These systems typically monitor user activities and attempt to create profiles of groups of users in order to create offers relevant to these users needs. This data is also useful to potential advertisers in selecting where to spend advertising dollars. However, none of these prior systems have been able to obtain information regarding each of the segments into which a user falls in real time using expressions run against user data as desired by an advertiser. By not being able to collect this data, prior systems cannot enable an advertiser to create a series of advertisements and present the most relevant advertisements to a user in real-time based upon determinations made about that user's recent and up-to-date activity.

### DESCRIPTION OF THE DRAWINGS

FIG. 1 is a diagram of a computer network.

FIG. 2 is a diagram of a computing device.

FIG. 3 is a diagram of a system for user-based segmentation and selection of offers.

FIG. 4 is a flowchart of data input.

FIG. 5 is a flowchart of segmentation.

FIG. 6 is a flowchart of user-based offer selection.

Throughout this description, elements appearing in figures are assigned three-digit reference designators, where the most significant digit is the figure number and the two least significant digits are specific to the element. An element that is not described in conjunction with a figure may be presumed to be the same as a previously-described element having the same reference designator.

### DETAILED DESCRIPTION

### Description of Apparatus

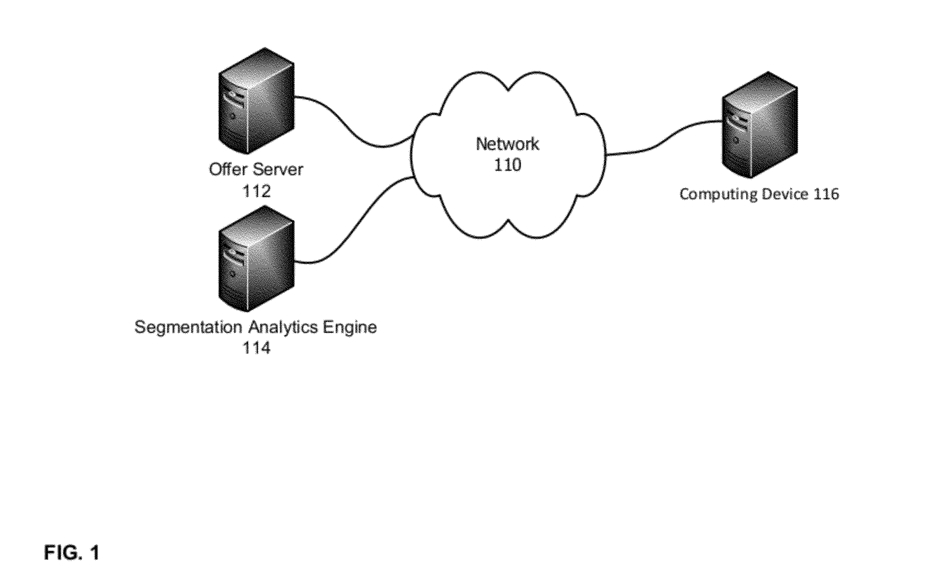

Referring now to FIG. 1, a network 110 is shown. An offer server 112, segmentation analytics engine 114 and computing device 116 are attached to the network 110.

The network 110 may take the form of a local network, a wide area network, the Internet or any number of other networks. The network 110 may be implemented locally by physically connected computers or may be distributed over a wide area.

The offer server 112 provides offers to the computing device 116 upon receipt of an offer requests. One offer server 112 is shown, but the offer server 112 may include one or more servers capable of providing offers. The offer server 112 may include one or more processors.

The segmentation analytics engine 114 collects data pertaining to a given user of a computing device 116. The segmentation analytics engine 114 then uses this data to provide user segments to an offer server 112 in response to segmentation or offer requests.

The computing device 116 is connected to the network. The computing device 116 is shown as a computer, but may take many forms. The computing device may be a personal computer, a mobile device, a tablet PC, a personal digital assistant, a smart phone, a “dumb” phone, a feature phone, a server computer operating as a part of a distributed or peer-to-peer network, or many other forms.

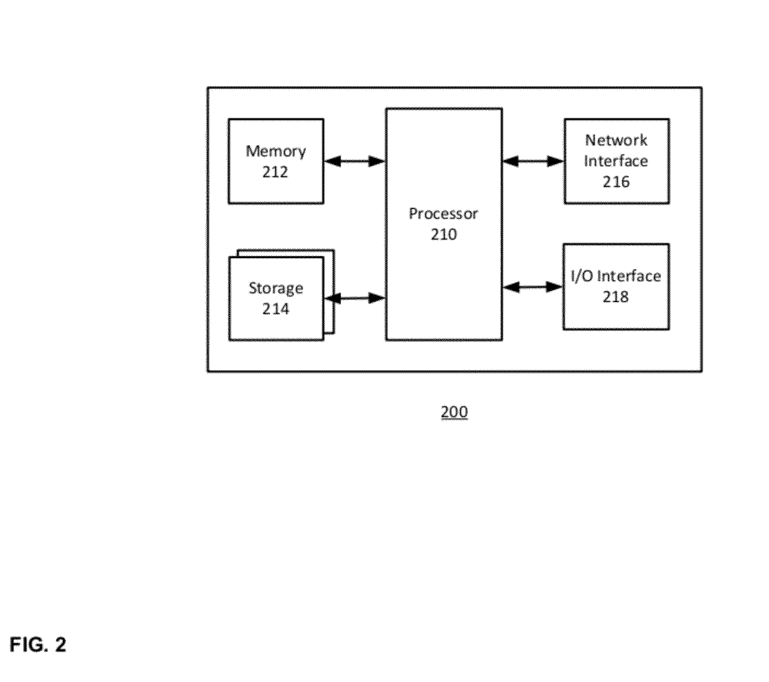

Turning now to FIG. 2 there is shown a computing device 200, which is representative of the server computers, client devices, mobile devices and other computing devices discussed herein. The computing device 200 may include software and/or hardware for providing functionality and features described herein. The computing device 200 may therefore include one or more of logic arrays, memories, analog circuits, digital circuits, software, firmware and processors. The hardware and firmware components of the computing device 200 may include various specialized units, circuits, software and interfaces for providing the functionality and features described herein.

The computing device 200 has a processor 210 coupled to a memory 212, storage 214, a network interface 216 and an I/O interface 218. The processor may be or include one or more microprocessors, field programmable gate arrays (FPGAs), application specific integrated circuits (ASICs), programmable logic devices (PLDs) and programmable logic arrays (PLAs).

The memory 212 may be or include RAM, ROM, DRAM, SRAM and MRAM, and may include firmware, such as static data or fixed instructions, BIOS, system functions, configuration data, and other routines used during the operation of the computing device 200 and processor 210. The memory 212 also provides a storage area for data and instructions associated with applications and data handled by the processor 210.

The storage 214 provides non-volatile, bulk or long term storage of data or instructions in the computing device 200. The storage 214 may take the form of a disk, tape, CD, DVD, or other reasonably high capacity addressable or serial storage medium. Multiple storage devices may be provided or available to the computing device 200. Some of these storage devices may be external to the computing device 200, such as network storage or cloud-based storage. In this patent, the term “storage medium” does not encompass transient media such as signals and waveforms that convey, but do not store information.

The network interface 216 includes an interface to a network such as network 110 (FIG. 1).

The I/O interface 218 interfaces the processor 210 to peripherals (not shown) such as displays, keyboards and USB devices.

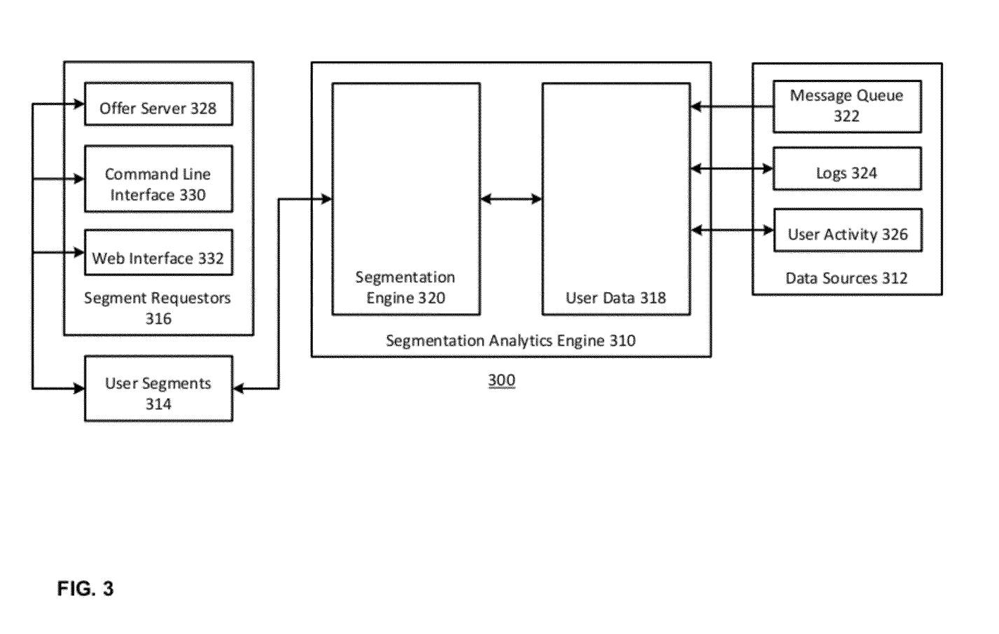

Turning now to FIG. 3, a diagram of a system 300 for user-based segmentation and selection of offers is shown. The system 300 includes a segmentation analytics engine 310, a number of data sources 312, user segments 314 and segment access sources 316. The segmentation analytics engine 310 includes user data 318 and a segmentation engine 320. The data sources 312 include a message queue 322, logs 324 and user activity 326. The segment requestors 316 include output interfaces such as an offer server 328, command line interface 330 and a web interface 332.

The segmentation analytics engine 310 including the segmentation engine 320 and user data 318 provides user segments 314 in response to segmentation requests received from the segment requestors 316. A segmentation request is a request to have user segments calculated or generated, either for real time use or for future use.

The user data 318 includes data regarding web searches, product searches, web sites viewed, products viewed and other data generated as a user browses the Internet. The user data 318 may be generated using a tracking pixel in conjunction with a cookie stored on a user's computer. Alternatively, it may be generated using a system signature created by an analysis of a user's computing device to thereby probabilistically determine that a given user is the same users over the course of a number of online activities. The user data 318 may also be generated using unique device identification such as MAC addresses or product identification numbers associated, for example, with some mobile devices. User data 318 may also include off-line data such as retail purchases attributed to a user, magazine or newspaper subscription data, or data collected from another source such as a user's purchase history.

An example of some of the user data 318 that may be tracked and maintained for a given user for use in creating user segments 314 is shown in table 1 below. Each of the “1”s in this table is a “true” indicating that the Variable Name of the indicated type exists for a given user. As the system continues to operate over time, additional values for each variable may be stored.

TABLE 1

| Variable Name | Money | Number | String | Time | List | Visit | Conversion |
|---|---|---|---|---|---|---|---|
| NumPageViews | | 1 | | | | | |
| FirstConversionTime | | | | 1 | | | |
| LastConversionTime | | | | 1 | | | |
| FirstVisitTime | | | | 1 | | | |
| LastVisitTime | | | | 1 | | | |
| NumVisits | | 1 | | | | | |
| LastDMA | | 1 | 1 | | | | |
| LastVisitCountry | | | 1 | | | | |
| LastVisitCity | | | 1 | | | | |
| LastVisitState | | | 1 | | | | |
| LastVisitPotalCode | | 1 | 1 | | | | |
| VisitURL | | | 1 | | | 1 | |
| VisitProductCategory | | | 1 | | | 1 | |
| VisitProductName | | | 1 | | | 1 | |
| VisitTime | | | | 1 | | 1 | |
| VisitProductPrice | 1 | | | | | 1 | |
| VisitProductSKU | | | 1 | | | 1 | |
| NumConversions | | 1 | | | | | |
| ConversionTime | | | | 1 | | | 1 |
| ConversionAmount | 1 | | | | | | 1 |
| NumProductPageViews | | 1 | | | | | |
| AvgProductPrice | 1 | | | | | | |
| MinProductPrice | 1 | | | | | | |
| MaxProductPrice | 1 | | | | | | |
| AvgConversionAmount | 1 | | | | | | |
| MinConversionAmount | 1 | | | | | | |
| MaxConversionAmount | 1 | | | | | | |
| CustomArgs | | | 1 | | 1 | | |
| ConversionProductCategory | | | 1 | | | | 1 |
| ConversionProductName | | | 1 | | | | 1 |
| ConversionProductPrice | 1 | | | | | | 1 |
| ConversionProductQuantity | | 1 | | | | | 1 |
| ConversionProductSKU | | | 1 | | | | 1 |

Each of the Variable Names corresponds to one or more variable types. The type may be money, a number, a string, a time, a list, a visit or a conversion. Money is a numerical price, average price, high and low price for the product or service. Money may also be the highest, average or lowest conversion amount for a product. Numbers are numerical values such as the prices or conversion amounts, but also the total number of page views associated with a product or the number of times a user has visited a particular site or any site including a particular product or product type.

Strings are character strings such as a URL a state or country of the user, or the names of products for which a user has searched. Time includes the timestamps associated with URL visits, searches, purchases conversions and similar activities. Lists may be groups of associated items or groups of products for which a user has searched. Visits may be the number of visits to a particular site by a user, number of visits to a product page, or the number of times a particular product price has been seen. Conversions may be the number of times an offer has been accepted or refused by a user.

These example variables include NumPageViews (the number of page views total), FirstConversionTime (the first time a user purchased based upon an offer), LastConversionTime (the last time a user purchased based upon an offer), FirstVisitTime (the first time a user visited a particular site), LastVisitTime (the last time a user visited a particular site), and NumVisits (the total number of visits to a particular site). The variables also include LastDMA (the last direct marketing access associated with the user's last known location), LastVisitCountry (the last country from which the user visited), LastVisitCity (the last city from which the user visited), LastVisitState (the last state from which the user visited), LastVisitPotalCode (the last postal code from which the user visited) and VisitURL (the URL the user visited).

Additional variables include VisitProductCategory (a product category associated with the URL visit, e.g., shoes, apparel, tools, furniture, etc.), VisitProductName (the name of the product), VisitTime (the time of the visit to the product), VisitProductPrice (the price of the product on the URL), and VisitProductSKU (the SKU associated with the product). Variables also include NumConversions (the number of times a user converted), ConversionTime (the timestamp of the conversion), ConversionAmount (the value of the conversion), NumProductPageViews (number of times the user has viewed pages with product), AvgProductPrice (the average price of that product across those pages), MinProductPrice (the lowest price of a viewed product) and MaxProductPrice (the highest price of a viewed product).

Variables may also include AvgConversionAmount (the average value of the conversion), MinConversionAmount (the lowest conversion value), MaxConversionAmount (the highest conversion value), CustomArgs (offer server user-defined arguments), ConversionProductCategory (the product category of the conversion), ConversionProductName (the product name for which a conversion occurred), ConversionProductPrice (the price of the sale at which the product for which a conversion occurred), ConversionProductQuantity (the number of product sold for which a conversion occurred) and ConversionProductSKU (the SKU of the product for which a conversion occurred).

These are only examples of the variables that may be maintained for a given user. Many other variables of various types may be stored as user data 318 for each user. This user data 318 may be accessed by the segmentation analytics engine 310 to provide user segments 314 in response to segmentation requests made by segment requestors 316.

The segmentation engine 320 receives segmentation requests from segment requestors 316 and then queries the user data 318 in order to create user segments 314 for the given user. These segmentation requests may take the form of one or more search queries or similar expressions. In practice, they operate upon available user data 318 pertaining to a user as a function-like call. Typical Boolean operators such as <, >, <=, >=, != may be used in addition to specialized function-like calls such as “contains( ) not contains( ) has, not has, count, min, max, average, first and last. Some operators may only be operable on some variable types, but in general any of these operators may be used in conjunction with any other. Additional and different function-like calls may be used in these segmentation requests.

For example, a segmentation request may take the form of a query such as “VisitUrl contains(guitar) AND NumPageView >=5”. Such a segmentation request would return a positive result if the user had visited a URL containing the word “guitar” and had a total of at least five URL views. Another segmentation request may take the form of a query such as “VisitUrl contains(guitar) HAS COUNT >=5”. Such a segmentation request would return a positive result if the user had visited a URL containing the word “guitar” at least five times. A segmentation request may include a plurality of these queries simultaneously. Each is simultaneously addressed by the segmentation analytics engine 310 to thereby generate user segments 314.

User segments 314, also called segment data, are generated in response to a segmentation request made to the segmentation analytics engine 310. The user segments 314 are positive or negative responses to function-like expressions chosen by segment requestors. The user segments 314 are created on a per-user basis. The user segments 314 are returned to an offer server so as to aid in selection of offers relevant to the user. Multiple user segments 314 may be requested simultaneously so as to quickly determine which of a number of offers may be relevant to a user.

User segments 314 may be created in real-time in response to ongoing user activity, such as a user activity 326, and are created in response to user segmentation requests from an offer server 328 as a user is loading a web page. User segments 314 may be created ahead of time based upon predetermined queries generated by an offer server 328 or segment requestor 316 related to a particular user. If the user segments 314 are generated ahead of time by the segmentation analytics engine 310, then they may be stored as user segments 314 in a data store. A user segment 314 may be updated should additional user data or data pertaining to a different segmentation request be added to the user data 318 from the data sources 312. User segments 314 may be collectively called user segment data.

The offer server 328 may determine that a particular user is browsing a web site or using a mobile application for which it serves offers. In response, the offer server 328 generates and sends a segmentation request to the segmentation analytics engine 310. The segmentation analytics engine 310 then creates the user segments 314 which are then returned to the offer server 328 which may then serve appropriate offers based upon the user segments 314 to the user. In some cases, the offer server 328 may request user segments for users that are to be cached for storage or analysis. These segments may be used to derive a clearer picture of the users of a site or to prepare offers for later use.

If the user segments indicate that none of the potential offers available to the offer server 328 is relevant or appropriate for a user, a default offer may be made. This may occur in situations in which there is sparse user data 318 or in which only a few user segments 314 are requested. An entity making offers may also indicate that it specifically does not wish to target certain users if the user segments 314 are of a particular form.

The user data 318 is gathered from a number of data sources 312. These sources include a message queue which may include external data feeds pertaining to a particular user. These may be feeds generated based upon tracking pixels, cookies and/or system signatures used on sites directly or indirectly accessible to the system 300.

The data sources 312 also include logs 324, such as logs of web pages that maybe parsed and added to the user data 318. Sites that do not use tracking pixels, cookie-based tracking, system signature tracking systems may provide logs 324 to the system 300 that are then parsed for relevant data pertaining to a particular user. That data is then added to the user data 318.

The data sources 312 may also include user activity 326. This user activity 326 may be direct activity by a user on a site available to the system 300. User activity 326 may include off-line data such as retail purchases that may be attributed to a user, magazine or newspaper subscription data, or data collected from another source such as a user's purchase history.

The user activity 326 may be a data feed provided in real-time of on-going user activity. This real-time user activity 326 data may be used to update the user data 318 such that it is always updated with the most relevant data useful to segment requestors 316. In this way, the user segments created with the user data 318 are always able to provide the most up-to-date segments. Additional data sources 312 may also exist, such as self-reported user data, data gleaned from outside sources or data aggregated by other products or services that may be added to the user data 318.

The offer server 328 is one of the available segment requestors 316. The offer server 328 may be hosted or operated separately from the remainder of the system 300. Only one offer server 328 is shown, but many offer servers may have access to user segments created by the segmentation analytics engine 310. Access to the segmentation analytics engine 310 may be made available using a username and password or using an API interface for direct access to the segmentation analytics engine 310 with a unique key or similar mechanism.

The offer server 328 may be an advertising server, specifically an advertising server serving display advertisements. However, any type of offer may be provided by an offer server 328. The offers may include discounts, specific product or service advertisements, suggestions to users based upon the user segments 314 or other types of offers.

The segmentation analytics engine 310 may suggest user segments 314 to the offer server 328 based upon user activity. These suggested user segments 314 may be relevant to the particular offer server or the ongoing user activity 326. The user segments 314 provided to the offer server 328 may be returned from the segmentation analytics engine 310 in extensible markup language (XML) or in some other machine-readable form for ease of use by the offer server 328 in parsing the user segments 314 before making offers.

The segmentation requests are generated for a user by a segment trigger, such as a web page request made by the user, the web page incorporating a link that causes a segmentation request or a segmentation request built into a mobile application for use with a mobile device. The command line interface 330 and web interface 332 may also be used as a segment trigger. The command line interface 330 and web interface 332 access the segmentation analytics engine 310 to create and access user segments 314. An administrator or entity in the process of making offers may access the command line interface 330, for example with a username and password, and thereby directly pass segmentation requests to the segmentation analytics engine 310. Alternatively, a user may access a web interface 332 in order to form and pass segmentation requests to the segmentation analytics engine 310 to thereby create user segments 314. These user segments 314 generated for the command line interface 330 and web interface 332 may be in a more user-readable form than the XML provided to the offer server 328. The command line interface 330 and the web interface 332 may be used to obtain aggregate information about segmentation requests such as how many users of a site or mobile application belong to a particular segment.

### Description of Processes

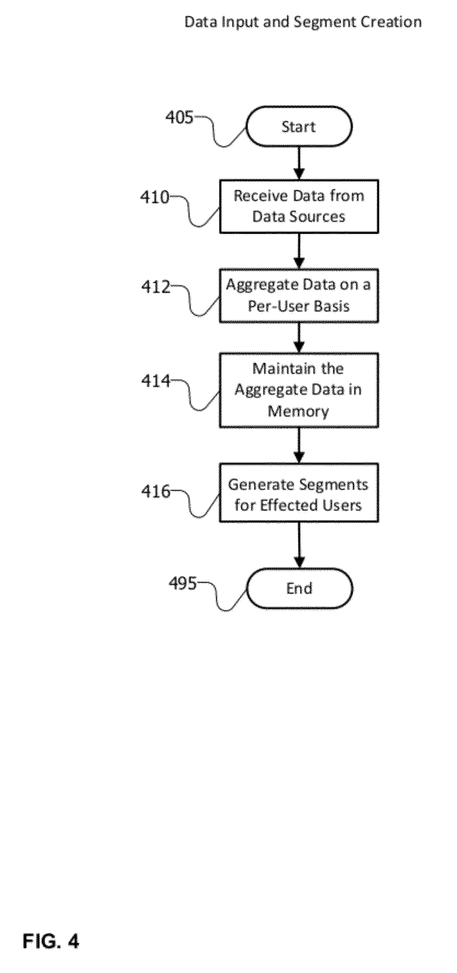

Turning now to FIG. 4, a flowchart of data input is shown. The user data is received from data sources at 410. This user data may be any of the types of data described above with reference to table 1 or additional types of data related to a user. Data is received on an on-going basis from one or more of the data sources 312 (FIG. 3).

Once the data is received it is aggregated on a per-user basis in the user data 318 (FIG. 3) at 412. The user data 318 is organized per-user so that segmentation requests may be directed to particular users. The aggregate data is maintained in memory (as opposed to storage) so that it may be accessed extremely quickly at 414. The data access may be required in a matter of milliseconds in order to provide a user segment in response to a segmentation request as a user-requested web page is in the process of loading.

The newly-added data may prompt the system to generate segments for users for which the new data is applicable at 416. For example, new data pertaining to a particular user may result in that user suddenly being relevant for a new offer or preexisting segmentation query. A new piece of data that indicates that a user is in the market for a baseball glove, for example, may cause the segmentation analytics engine 310 to determine that that user is now relevant to an offer for baseball equipment. In response to the new data, user segments related to that user may be created at 416.

The flow chart has both a start 405 and an end 495, but the process is cyclical in nature. Portions of the process may be accomplished in parallel or serially. Multiple instances of the process may be taking place in parallel or serially.

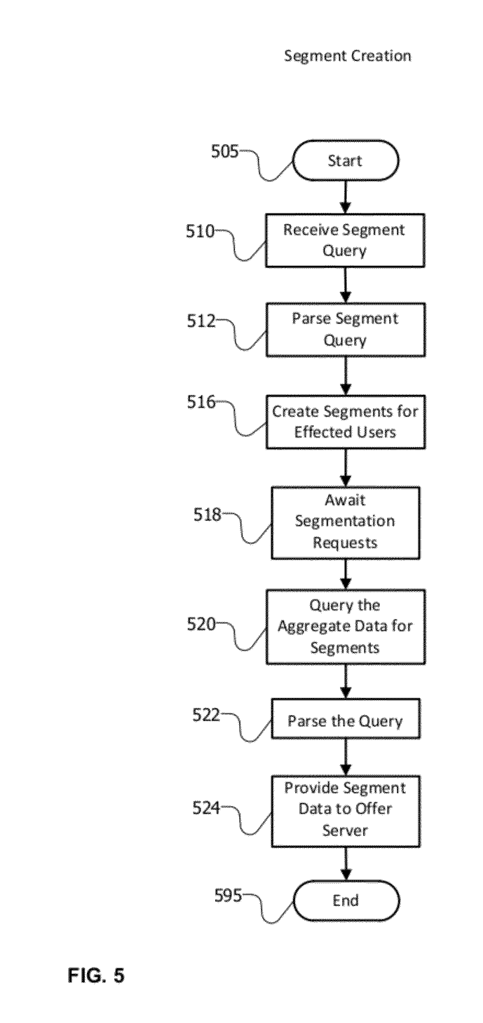

Turning now to FIG. 5, a flowchart of segmentation is shown. This is the process by which user segments are created. First, a segment query is received at 510. The segment query may take the form of a function-like call. The segment query is parsed at 512. The parsing operates on the function-like call with reference to the aggregate user data in order to derive users relevant to the segment query. Segments may be requested immediately in response to the segment query. User segments for these users relevant to the segment query are created at 516.

The parsed segment queries are also maintained for subsequent segmentation requests at 518. These segmentation requests occur, for example, as a user is browsing a website. The user's browser triggers a link or tracking pixel that requests a segment for that user. Based upon the previously entered segment query at 510, the aggregate user data is queried for segments relevant to the user at 520. This query is first passed in order to find the user, then to identify segments for which that user is relevant at 522.

Next, segment data is provided to the offer server at 524. This segment data may include one or more segments that are relevant to a particular user. The segment data may be used by the offer server to select an offer to be presented to the user. In some cases, the offer server may disregard the segment data, for example, if another offer has priority over any of the segments relevant to the user.

In this way, the user segments 314 may be provided to an offer server in response to segmentation requests at 518 from the offer server so that the offer server may select an appropriate offer for the user based upon the user segments 314 associated with that user. This offer may be a text-based offer, a pre-determined, so-called “display” advertisement or other type of offer.

The flow chart has both a start 505 and an end 595, but the process is cyclical in nature. Portions of the process may be accomplished in parallel or serially. Multiple instances of the process may be taking place in parallel or serially.

In both FIG. 4 and FIG. 5, the user segments 314 (FIG. 3) are created on a per-user basis in response to the segment queries associated with a given offer server or organization utilizing the offer server. For example, a company may utilize the offer server to create a series of ten segment queries beforehand. Once a user requests a webpage on a site associated with that company, the offer server will immediately send the segmentation request incorporating all ten predetermined queries. The segmentation request will return a “yes” or “no” response for each query. Segmentation requests may also be prompted when new user data is available as described in FIG. 4, or upon the entry of a new segmentation query as described in FIG. 5.

One such segmentation query may be the query described above as “VisitUrl contains(guitar) AND NumPageView >=5”. If the result of this query is positive, then the company may direct the offer server to present advertisements or other offers related to guitars. These advertisements or other offers may include offers for musical instruments, musical equipment, recording equipment or services, concert tickets or other offers. If the result is negative, then the offer server may be directed to present a generic offer. Alternatively, different offers associated with queries for which a positive result was returned may be presented to the user.

Organizations wishing to perform analytics on their user base may also request user segments before any offer is to be made. In these instances, the offer server may request segments for a group of users or all users en masse and, thereafter, the segmentation analytics engine will provide positive and negative responses for each of the requested users. This type of data may be useful in determining more detailed information about the user base for the organization's site. If large percentages of the organization's site are interested in guitars, for example, more information and articles may be presented associated with guitars and music in general. In addition, the organization may go to potential advertisers and present the information in order to suggest that advertisement on the organization's site will reach relevant and interested consumers.

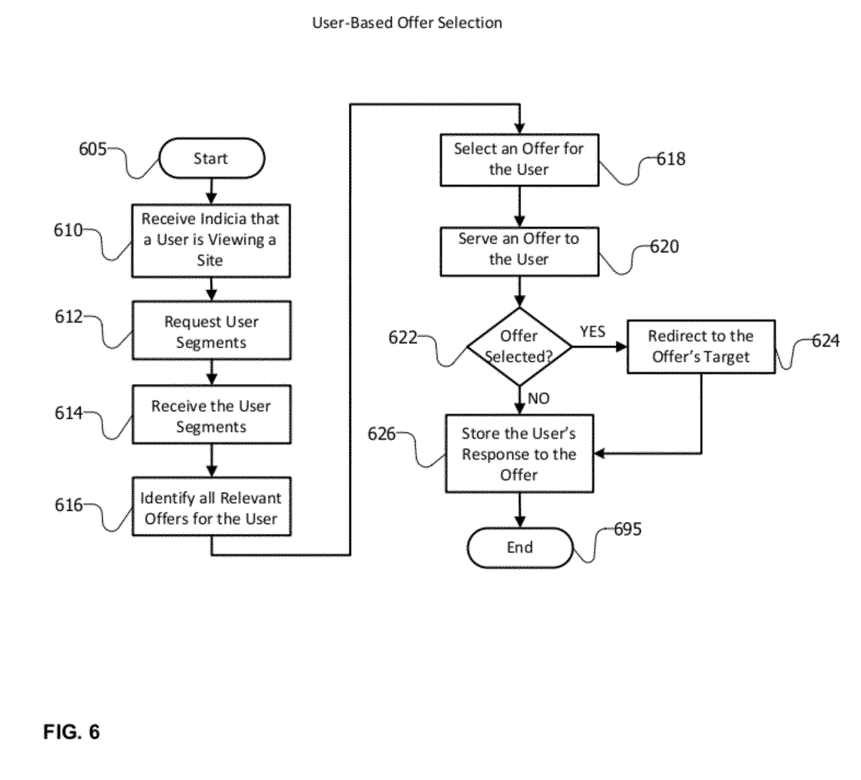

Turning now to FIG. 6, a flowchart of user-based offer selection is shown. This is the process by which a user-based offer is selected and provided to the user. Initially, the offer server 328 (FIG. 3) receives indicia that a user is viewing a site at 610. These indicia may arrive by means of a tracking pixel, a cookie or a system signature. In response to these indicia, the offer server 328 requests user segments 612. This request is forwarded to the segmentation analytics engine 310 (FIG. 3). The segmentation analytics engine 310 then creates segments for the user based upon the data available. The user segments 314 are then sent to the offer server 328.

The segmentation request includes one or more queries that are directed to prior user activity. These queries return results that are either positive or negative. For example, a segmentation request may include a query regarding whether the user has viewed five commercial websites offering to sell books in the last six weeks. If the result is positive, that positive indication is returned to the offer server. Another query may be used to determine that the user has not purchased shoes online in the last six months. A negative result may be returned to the offer server for that query. A related query may ask whether the user has ever purchased shoes using the Internet. If so, a positive result will be returned to the offer server for that query. Those two results, negative and positive, may prompt the offer server to provide an offer of a discount on a shoe purchase for an advertiser on the site.

The offer server 328 then receives the requested user segments 614 and, thereby, identifies all relevant offers for the user 616. These offers may be identified based upon the user segments received at 614. An individual offer may then be selected for the user at 618, based upon priority, weighting and the like. For example, each of the offers associated with an offer server may have a particular weight based upon their desirability to the entity making the offer. Each of the offers may have a priority by which one offer is to be presented to a user before another offer is presented. The priority, weighting or preferred selection of offers may be set by the entity making the offers or may be the subject of a real-time auction for the right to make the offer.

The offer server 328 then serves an offer to the user at 620. The selected offer may, ultimately, be the result of the user segments received or may be based, solely, upon the priority of the offers. Both factors may also be taken into account. The offer may be a text-based offer, a pre-determined, so-called “display” advertisement or other type of offer.

The user then may decide whether or not to select the offer at 622. If yes, then the user is redirected to the offer's target 624. If the user does not respond or once the user has been redirected, the user's response to the offer is stored 626. This response will create additional data for use in later use segments requested for the same user.

The flow chart has both a start 605 and an end 695, but the process is cyclical in nature. Portions of the process may be accomplished in parallel or serially. Multiple instances of the process may be taking place in parallel or serially.

### CLOSING COMMENTS

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A method for user-based segmentation and selection of offers comprising:
aggregating user activity data comprising online activity of a user;
generating user segment data in response to a segment trigger and in response to a segmentation request, the user segment data incorporating Boolean responses to a plurality of predetermined user queries based upon the user activity data; and
providing the user segment data to an offer server in response to the segmentation request from the offer server.

2. The method of claim 1 further comprising making an offer to the user based upon the user segment.

3. The method of claim 2 wherein the offer includes a display advertisement predetermined based upon the user segment data.

4. The method of claim 2 wherein the offer includes a default advertisement if the results of the user segment data indicate that the user fails to conform to any desired user segment.

5. The method of claim 1 wherein the online activity of a user includes browsing a plurality of web pages related to a particular product type.

6. The method of claim 1 wherein the segment request includes an expression describing one of the user queries requested by the offer server.

7. The method of claim 1 wherein the user activity data is maintained in random access memory.

8. The method of claim 1 wherein the user segment data is provided to the offer server as the user is accessing a network.

9. The method of claim 1 wherein the user segment data is used by the offer server to analyze a plurality of users including the user.

10. An apparatus for user-based segmentation and selection of offers comprising a segmentation engine operating on a segmentation server, the segmentation engine for:
aggregating user activity data based upon online activity of a user;
generating user segment data in response to a segment trigger and a segmentation request, the user segment data incorporating a plurality of Boolean responses to user queries based upon the user activity data; and
providing the user segment data to an offer server in response to the segmentation request from the offer server.

11. The apparatus of claim 10 further comprising the offer server for making an offer to the user based upon the user segment.

12. The apparatus of claim 11 wherein the offer includes a display advertisement predetermined based upon the user segment.

13. The apparatus of claim 10 wherein the online activity of a user includes browsing a plurality of web pages or mobile apps related to a particular product type.

14. The apparatus of claim 10 wherein the segment request includes an expression describing one of the user queries requested by the offer server.

15. The apparatus of claim 10 further comprising random access memory for maintaining the user activity data.

16. The apparatus of claim 10 wherein the user segment data is provided to the offer server as the user is accessing a network.

17. The method of claim 10 wherein the user segment data is used by the offer server to analyze a plurality of users including the user.

18. Apparatus comprising a storage medium storing program instructions which when executed by a processor will cause the processor to:
aggregate user activity data based upon online activity of a user;
generate user segment data in response to a segment trigger and a segmentation request, the user segment data incorporating a plurality of Boolean responses to user queries based upon the user activity data; and
provide the user segment data to an offer server in response to the segmentation request from the offer server.

19. The apparatus of claim 18 wherein the instructions further cause the processor to make an offer to the user based upon the user segment.

20. The apparatus of claim 19 wherein the offer includes a display advertisement predetermined based upon the user segment.

21. The apparatus of claim 18 wherein the offer includes a default advertisement if the results of the user segment data indicate that the user fails to conform to any desired user segment.

22. The apparatus of claim 17 wherein the online activity of a user includes browsing a plurality of web pages related to a particular product type.

23. The apparatus of claim 17 wherein the segment request includes an expression describing one of the queries requested by the offer server.

24. The apparatus of claim 17 wherein the user activity data is maintained in random access memory.

25. The apparatus of claim 17 wherein the user segment data is provided to the offer server as the user is accessing a network.

26. The apparatus of claim 17 wherein the user segment data is used by the offer server to analyze a plurality of users including the user.
